(19) United States
(12) Patent Application Publication
(10) Pub. No.: US 2022/0025625 A1
(43) Pub. Date: Jan. 27, 2022

(54) Portable Hand-Washing Station with Grey-Water Discharge Prevention

(71) Applicant: J & J Portable Sanitation Products, LLC, Crawford, PA (US)

(72) Inventor: Matthew D. Roncadori, Stephens, GA (US)

(73) Assignee: J & J Portable Sanitation Products, LLC, Crawford, GA (US)

(21) Appl. No.: 17/012,040

(22) Filed: Sep. 3, 2020

Related U.S. Application Data
(63) Continuation-in-part of application No. 16/937,918, filed on Jul. 24, 2020.

(51) Int. Cl. E03C 1/23; E03C 1/182

(52) U.S. Cl. CPC E03C 1/23; E03C 2001/2313; E03C 1/182

(57) ABSTRACT

A portable hand-washing station having a base, at least one sink thereabove, a grey-water storage tank in the base, and a suction tube extending from an inlet end thereof within the grey-water storage tank upwardly and from there downwardly to an outlet end thereof at a bottom portion of the base, the suction tube having a check valve in it which has a cracking pressure sufficient to prevent flow from the grey-water storage tank through the suction tube without application of suction at the outlet to overcome the cracking pressure.

### RELATED APPLICATIONS

This application is a continuation-in-part of application Ser. No. 16/937,918 filed on Jul. 24, 2020.

### FIELD OF THE INVENTION

This invention is generally related to systems for controlling and disposing of grey water in and from grey-water collectors in a variety of portable or non-stationary devices and, more particularly, in and from portable wash-basin stations for hand-washing and the like.

### BACKGROUND OF THE INVENTION

The invention disclosed herein is an improved portable hand-washing station of the type having, among other things, a sink, a grey-water storage tank for receiving used water draining from the sink, and a suction tube for use in periodic emptying of the grey-water storage tank. Such hand-washing stations are typically installed temporarily for use at temporary events/locations (both indoors and outdoors) in which large crowds are gathered (e.g., fairs, musical events, sporting events, and the like) and also at sites for construction, renovation, and other similar work sites. These are all typically situations in which external drainage of grey water from such hand-washing stations is not possible, so that suction from station's grey-water storage tanks typically involves flow into a large used-water disposal tank, typically on a truck or service vehicle.

Often, a large number of such portable hand-washing stations are installed at a particular installation site and periodically serviced at that site during the installation period, and also typically serviced just after, or in some cases, just before a period of temporary installation. Rapid and tidy servicing is very desirable, particularly but not only when large numbers of stations are installed at a site. Emptying the grey-water storage tanks is a task that can and does lead to leakage and spillage of grey water onto the surface on which the stations are placed, whether such surface is ground (e.g., grass, dirt or sand), pavement or even flooring, and leakage and spillage can tend to make the area unattractive or unsightly, or in certain situations even slippery.

Various portable hand-washing sink units that deal with the matter of periodic emptying (either complete or partial) of grey water from grey-water storage tanks are known. There is a need for an improved portable hand-washing station which can allow rapid removal of grey water from its grey-water storage tank and into a transportable disposal tank to thereafter be driven off-site. While the problems addressed by this invention pertain most particularly to portable hand-washing stations, which are frequently used in groups at a single big-event site, the principles of this invention also apply with respect to the emptying of grey-water storage tanks in other applications

The principal object of this invention is to provide improved grey-water storage-tank emptying, either complete or partial, which provides rapid emptying of grey-water while minimizing or eliminating leakage and spillage during rapid hook-up for suction removal, rapid detachment after suction removal, and even during periods between servicing when grey water is being stored in its storage tank—in order to avoid unattractive, unsightly, or even dangerous conditions at and nearby the devices. The inventive concept of this application involves placing a check valve in the drain line of a grey-water storage tank in order (1) to prevent unwanted drainage/leakage from the tank and (2) to provide a simple, suction-enabled drain connection to the storage tank.

### SUMMARY OF THE INVENTION

In particular preferred forms, this invention is an improvement in a portable hand-washing station that has a base, at least one sink above the base, a grey-water storage tank in the base configured to receive grey water draining from the sink(s), and a suction tube extending from an inlet end thereof within the grey-water storage tank upwardly and from there downwardly, either inside or outside the grey-water tank, to an outlet end thereof at a bottom portion of the base. The invention is characterized by a check valve in the suction tube, the check valve having a cracking pressure sufficient to prevent flow from the grey-water storage tank through the suction tube without application of suction at the outlet to overcome the cracking pressure.

In one preferred embodiment, the check valve is at the inlet end, within the grey-water storage tank. In some embodiments, the check valve is positioned outside the grey-water storage tank. The suction tube preferably has a highest point positioned above a highest level of grey-water storage, and in certain of such embodiments, it is preferred that the check valve in the tube be positioned above the highest level of grey-water storage, which in some situations can facilitate accessibility to the check valve. In some embodiments, it is preferred to also have an outlet valve at the outlet end of the suction tube.

In another preferred embodiment, the check valve is at the outlet end of the suction tube.

In some other preferred embodiments, the check valve is a first check valve and the apparatus includes a second check valve in the suction tube. In some of these embodiments, the first check valve is at the inlet end of the suction tube and the second check valve is at the outlet end of the suction tube.

More broadly defined this invention is apparatus for emptying grey water from a grey-water storage tank by suction that includes a suction tube extending from an inlet end thereof within the grey-water storage tank upwardly and from there downwardly, either inside or outside the grey-water tank, to an outlet end thereof at a bottom portion of the grey-water storage tank, and a check valve in the suction tube, the check valve having a cracking pressure sufficient to prevent flow from the grey-water tank through the suction tube without application of suction at the outlet to overcome the cracking pressure.

This invention provides the intended advantages as described above. Rapid emptying of grey-water tanks is provided while minimizing or avoiding leakage and spillage of grey water, and the attendant associated problems.

The meanings of the words and phrases used in this document, including in the below claims, are well understood by persons having skill with respect to portable hand-washing stations. As is apparent, the term “grey water” as used herein refers to the waste water which has drained from the sinks of a portable hand-washing station.

### BRIEF DESCRIPTION OF THE DRAWINGS

FIGS. 1A-1C are three perspective-view illustrations of an embodiment of the inventive portable dual-sink hand-washing station disclosed herein. FIG. 1A is a view generally from the side of the station which shows the outlet (drain) of the grey-water storage tank at the bottom portion of the station base. FIG. 1B is a view generally from a side of the station facing the front edge of one of the sinks. FIG. 1C is a view generally from the side of the station opposite to that of FIG. 1A.

FIG. 2 is top-view illustration of the sink structure of the hand-washing station embodiment of FIGS. 1A-1C with accessories removed from the station top.

FIG. 3 is a perspective view of the station top and sink structure of the hand-washing station embodiment of FIGS. 1A-1C, including one spigot and the accessories (towel and soap dispensers).

FIG. 4 is a side elevation of the hand-washing station embodiment of FIGS. 1A-1C.

FIG. 5 is a front elevation of the hand-washing station embodiment of FIGS. 1A-1C.

FIG. 6A is a top-view illustration of the portable hand-washing station embodiment of FIGS. 1A-1C with the station top and sink structure removed.

FIG. 6B is a cutaway illustration of the base, fresh-water tank and suction tube of the hand-washing station embodiment of FIGS. 1A-1C.

FIG. 6C is a perspective-view illustration of the hand-washing station embodiment of FIGS. 1A-1C with just the elements of the grey-water removal system which prevents grey-water discharge in the absence of sufficient suction.

FIG. 6D is a perspective-view illustration similar to that of FIG. 6B but with the addition of the bottom portion of the base of the station.

FIGS. 7A-7D are four modified fluid-flow schematics of various embodiments of the grey-water removal system of the portable hand-washing station of this invention. FIGS. 7A-7D illustrate the ascending portion of the suction tube inside the grey-water tank and the descending portion of the tube outside the grey-water tank. FIG. 7A illustrates a check valve at the inlet of the suction tube. FIG. 7B illustrates the check valve at the highest point of the suction tube with such point being above the highest level of grey-water storage. FIG. 7C illustrates the check valve outside of the grey-water tank. FIG. 7D illustrates a configuration similar to that of FIG. 7A but with the addition of a valve at the outlet end of the suction tube.

FIGS. 8A-8D are four modified fluid-flow schematics which correspond to FIGS. 7A-7D, respectively, but with both the ascending and descending portions of the suction tube being inside the grey-water storage tank.

FIG. 9 is a modified fluid-flow schematic of another alternative embodiment of the grey-water removal system of the portable hand-washing station of this invention, this embodiment having a check valve at the outlet end of the suction tube.

FIG. 10 is a modified fluid-flow schematic of one more alternative embodiment of the grey-water removal system of the portable hand-washing station of this invention, this embodiment having a first check valve at the inlet end of the suction tube and a second check valve at the outlet end of the suction tube.

### DETAILED DESCRIPTION OF PREFERRED EMBODIMENTS

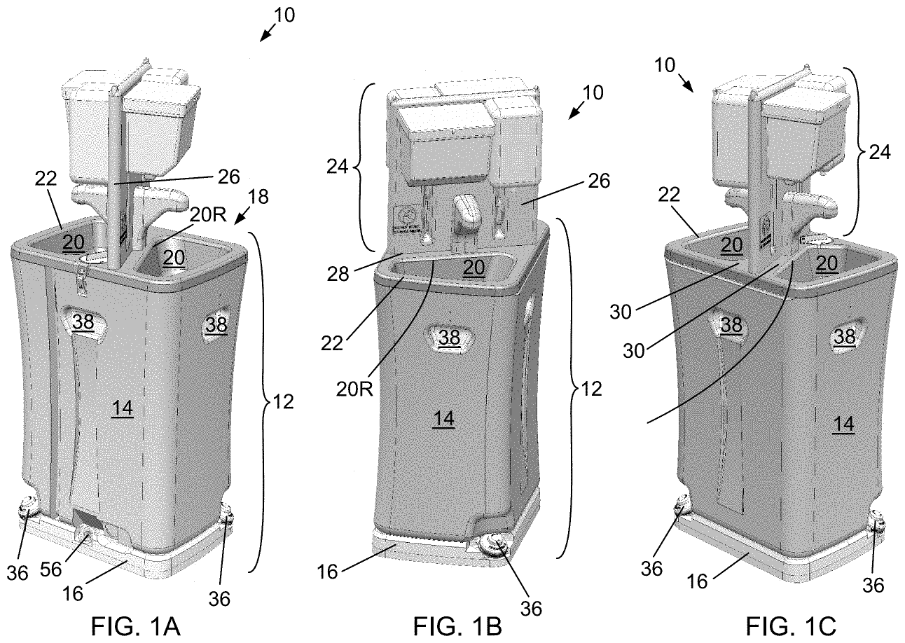

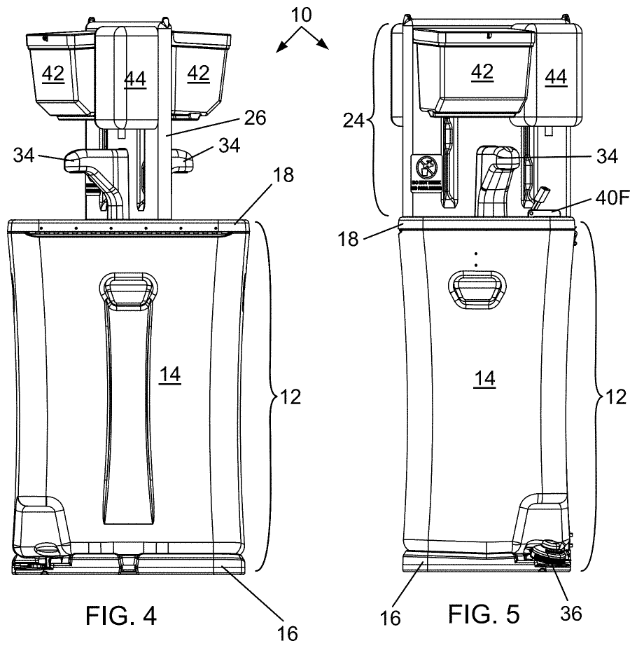

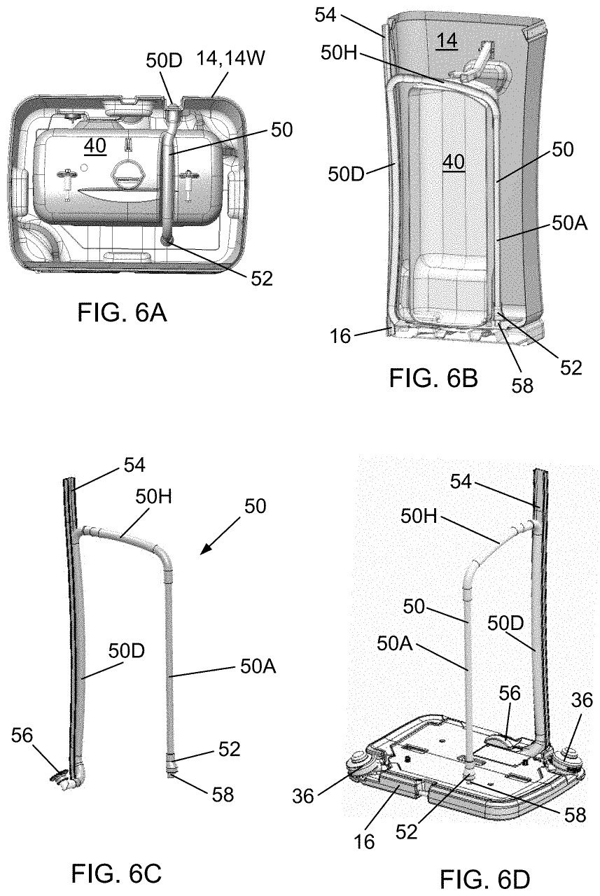

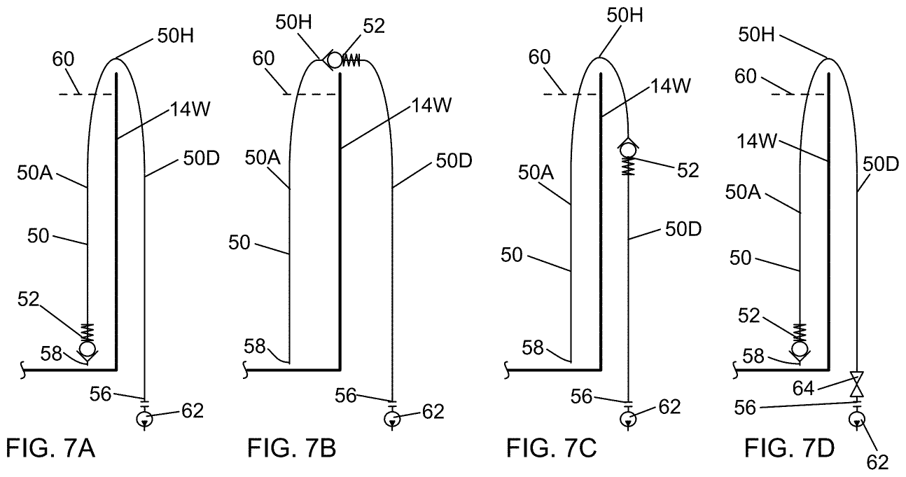

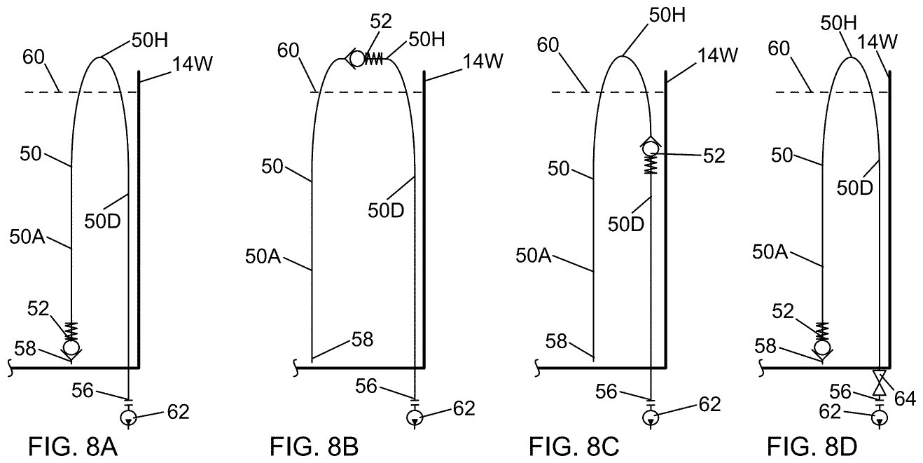

FIGS. 1A through 6D present various views and levels of detail of one or more embodiments (or portions thereof) of the inventive portable hand-washing station described herein. FIGS. 7A through 8D present schematic drawings which provide detailed description of pertinent fluid-flow portions of the hand-washing station. Reference numbers of like parts are the same, but not all views include a full complement of reference numbers in order to prevent cluttering the figures. FIGS. 6A through 8D are the drawings particularly related to the invention claimed herein.

FIGS. 1A-1C are three perspective-view illustrations (from three different angles) of an embodiment 10 of the inventive portable hand-washing station disclosed herein, hereinafter referred to as station 10 or embodiment 10. Station 10 described herein is a dual-sink station, but the dual-sink feature of such a representative portable hand-washing station is in no way limiting with respect to the inventive improvement to the system by which the grey-water storage tank is emptied. Furthermore, the use of representative embodiment 10 does not limit the inventive concept to embodiments which are portable hand-washing stations.

Station 10 includes a base 12 which supports a sink structure 18 above base 12. Sink structure 18 defines a substantially-horizontal upper surface area 22. Station 10 also includes a station top 24 supported above sink structure 18 and includes vertical support structure 26 which defines a diagonal divide 28 of upper surface area 22 into two sections 30. Each section 30 has a sink opening 20 which has a rear edge 20R along vertical support structure 26 such that each sink opening 20 has a larger end 20L and a smaller end 20S. Each larger end 20L provides increased clearance for the hand-scrubbing action within sink 20. Diagonal divide 28 also serves to increase the maximum length within sink 20 available to accommodate forearm-scrubbing. (Note that reference number 20 refers herein to both sink opening 20 and sink 20 for purposes of simplicity.)

Base 12 of station 10 includes a main upper structure 14 which in embodiment 10 is also a grey-water storage tank 14. Base 12 also includes a bottom portion 16 which is also referred to as a ground-engaging lower structure 16. Ground-engaging lower structure 16 includes two pump units 36, one for each sink 20 of station 10. Pumps 36 may be actuated by a user's foot and provide a flow of fresh water from a fresh-water storage tank 40 (see FIG. 6A) through spigots 34, one for each sink 20. As seen in FIGS. 1A-1C, base 12 also includes four handles 38 spaced around base 12.

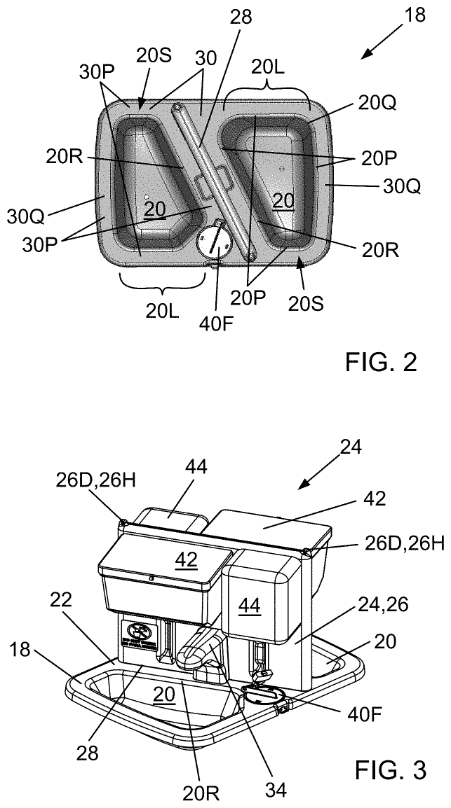

FIG. 2 is top-view illustration of sink structure 18 showing diagonal divide 28 of vertical support structure 26 from which station-top 24 accessories have been removed to show upper surface area 22 of sink structure 18 more easily. Upper surface area 22 is clearly shown as divided into two quadrilateral sections 30Q, and each sink 20 has its rear edge 20R along vertical support structure 26. Sections 30 each have two pairs 30P of opposite sides of unequal length (only one such pair 30P indicated by reference number). Quadrilateral section 30Q on the right side of FIG. 2 includes a quadrilateral sink opening 20Q having two pairs 20P of opposite edges of unequal length. Both sinks 20 include larger and smaller ends 20L and 20S, respectively.

Sink structure 18 also includes a fresh-water fill port 40F through which fresh-water storage tank 40 may be filled. Again referring to FIGS. 1A-1C and also to FIGS. 3-5, station top 24 includes accessories mounted on vertical support structure 26. In embodiment 10, such station accessories include towel dispensers 42 and soap dispensers 44. Vertical support structure 26 of station top 24 also includes two vertical post structures 26P each at an opposite end of diagonal vertical support structure 26, and each post structure 26P has a post distal end 26D which forms a hang-member 26H for user accessories. In station 10, hang-members 26H are integrally-formed with top structure.

FIGS. 6A-6D are a set of perspective-view illustrations of portions of station 10 to illustrate the elements of the grey-water removal system which prevents grey-water discharge in the absence of sufficient suction. FIGS. 6A and 6B show fresh-water storage tank 40 inside of grey-water storage tank 14 from top and side cutaway views, respectively. All four illustrations, FIGS. 6A-6D, show suction tube 50 and check valve 52, and FIGS. 6B-6D each also show ascending 50A and descending 50D portion of suction tube 50 and highest point 50H of suction tube 50. Station 10 includes a suction-tube sheath 54 which surrounds descending portion 50D of suction tube 50 which is outside of grey-water storage tank 14 (also main upper structure 14).

In embodiment 10, check valve 52 is positioned in suction tube 50 at an inlet end 58 of suction tube 50. Check valve 52 is configured to have a cracking pressure sufficient to prevent flow from the grey-water storage tank through the suction tube without application of suction at the outlet to overcome the cracking pressure. In other words, check valve 52 prevents any siphoning flow from grey-water storage tank 14 from occurring in station 10. Thus, a suction force applied at suction-tube outlet end 56 which is sufficient to overcome the cracking pressure is necessary for removal of grey-water from tank 14; no flow of grey-water from station 10 will occur without such level of suction.

FIGS. 7A-7D are four modified fluid-flow schematics of various embodiments of the grey-water removal system of the portable dual-sink hand-washing station of this invention. These fluid-flow schematics are said to be modified since they include some aspects of the geometry of the flow path along suction tube 50 to illustrate the physical relationships between various elements of the schematics. In these figures, grey-water tank 14 is indicated by a portion 14W of the wall of tank 14.

FIGS. 7A-7D illustrate ascending portion 50A of suction tube 50 inside grey-water tank 14 and descending portion 50D of suction tube 50 outside of grey-water tank 14. Each of these figures includes a suction pump 62 which is temporarily connected to outlet end 56 in order to provide the suction necessary for removal of grey-water from grey-water storage tank 14. FIG. 7A shows check valve 52 at inlet end 58 of suction tube 50 as it is in embodiment 10. Check valve 52 may be positioned at any other location along suction tube 50. FIG. 7B shows check valve 52 at highest point 50H of suction tube 50 with such point being above a highest level 60 of grey-water in grey-water storage tank 14. (Note that highest level 60 of grey-water may be above highest point 50H, although this configuration is not shown.) FIG. 7C shows check valve 52 outside of grey-water storage tank 14.

FIG. 7D illustrates an alternative embodiment similar to that of FIG. 7A but with the addition of an outlet valve 64 at outlet end 56 of suction tube 50. Valve 64 may be used to prevent ingress of dirt into outlet end 56, to capture drips from the inside surface of descending portion 50D of suction tube 50 after grey-water removal by suction is complete, or to otherwise protect suction-tube outlet end 56.

FIGS. 8A-8D are four modified fluid-flow schematics of various alternative embodiments of the grey-water removal system of the portable hand-washing station of this invention. FIGS. 8A-8D correspond to FIGS. 7A-7D, respectively, but with both ascending 50A and descending 50D portions of suction tube 50 being inside grey-water storage tank 14.

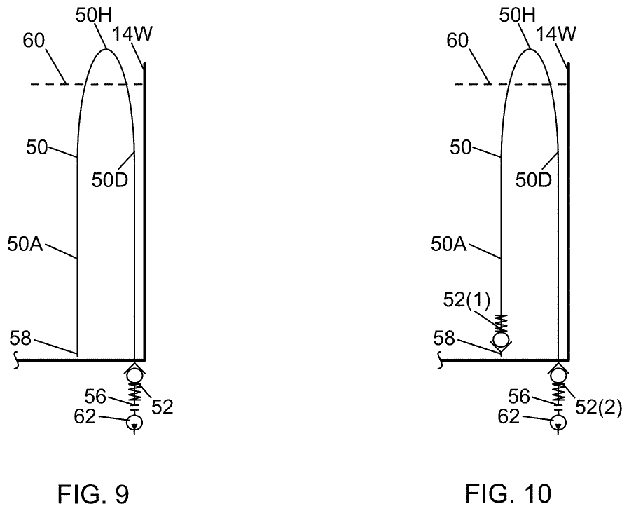

FIG. 9 is a modified fluid-flow schematic of another alternative embodiment of the grey-water removal system of the portable hand-washing station of this invention. In this alternative embodiment, check valve 52 is at outlet end 56 of suction tube 50. Placing check valve 52 at outlet end 56 serves to minimize any spillage from suction tube 50, a highly desirable performance feature which may be particularly important to prevent releasing dangerous organisms such as the coronavirus or other similar unwanted material in public spaces.

FIG. 10 is a modified fluid-flow schematic of a one more alternative embodiment of the grey-water removal system of the portable hand-washing station of this invention. The embodiment of FIG. 10 includes a first check valve 52(1) at inlet end 58 of suction tube 50 and a second check valve 52(2) at outlet end 56 of suction tube 50. Having more than one check valve in suction tube 50 provides backup to further assure that grey water storage tank 14 only is emptied when suction is applied at outlet end 56 of suction tube 50.

While the illustrated embodiment is a portable hand-washing station, the invention is also applicable to the emptying of grey-water storage tanks of other devices.

While the principles of this invention have been described in connection with specific embodiments, it should be understood clearly that these descriptions are made only by way of example and are not intended to limit the scope of the invention.

1. In a portable hand-washing station having a base, at least one sink thereabove, a grey-water storage tank in the base to receive grey water draining from the sink(s), and a suction tube extending from an inlet end thereof within the grey-water storage tank upwardly and from there downwardly to an outlet end thereof at a bottom portion of the base, the improvement comprising a check valve in the suction tube, the check valve having a cracking pressure sufficient to prevent flow from the grey-water storage tank through the suction tube without application of suction at the outlet to overcome the cracking pressure.

2. The portable hand-washing station of claim 1 wherein the check valve is at the inlet end.

3. The portable hand-washing station of claim 1 wherein the check valve is positioned outside the grey-water storage tank.

4. The portable hand-washing station of claim 1 wherein the suction tube has a highest point positioned above a highest level of grey-water storage.

5. The portable hand-washing station of claim 4 wherein the check valve is positioned in the tube above the highest level of grey-water storage.

6. The portable hand-washing station of claim 1 further including an outlet valve at the outlet end of the suction tube.

7. The portable hand-washing station of claim 1 wherein the check valve is at the outlet end.

8. The portable hand-washing station of claim 1 wherein the check valve is a first check valve and the apparatus further includes a second check valve in the suction tube.

9. The portable hand-washing station of claim 8 wherein the first check valve is at the inlet end and the second check valve is at the outlet end.

10. Apparatus for emptying grey water from a grey-water storage tank by suction comprising:
a suction tube extending from an inlet end thereof within the grey-water storage tank upwardly and from there downwardly to an outlet end thereof at a bottom portion of the grey-water storage tank; and
a check valve in the suction tube, the check valve having a cracking pressure sufficient to prevent flow from the grey-water tank through the suction tube without application of suction at the outlet to overcome the cracking pressure.

11. The grey-water emptying apparatus of claim 10 wherein the check valve is at the inlet end.

12. The grey-water emptying apparatus of claim 10 wherein the check valve is positioned outside the grey-water storage tank.

13. The grey-water emptying apparatus of claim 10 wherein the suction tube has a highest point positioned above a highest level of grey-water storage.

14. The grey-water emptying apparatus of claim 13 wherein the check valve is positioned in the tube above the highest level of grey-water storage.

15. The grey-water emptying apparatus of claim 10 further including an outlet valve at the outlet end of the suction tube.

16. The grey-water emptying apparatus of claim 10 wherein the check valve is at the outlet end.

17. The grey-water emptying apparatus of claim 10 wherein the check valve is a first check valve and the apparatus further includes a second check valve in the suction tube.

18. The grey-water emptying apparatus of claim 17 wherein the first check valve is at the inlet end and the second check valve is at the outlet end.
